(19) United States
(12) Patent Application Publication
(10) Pub. No.: US 2008/0141160 A1
(43) Pub. Date: Jun. 12, 2008

(54) SYSTEMS, METHODS, DEVICES, AND COMPUTER PROGRAM PRODUCTS FOR ADDING CHAPTERS TO CONTINUOUS MEDIA WHILE RECORDING

(75) Inventor: Miika Vahtola, Oulu (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/608,075

(22) Filed: Dec. 7, 2006

(51) Int. Cl. G06F 3/048; G06F 17/30

(52) U.S. Cl. 715/772; 707/104.1; 707/E17.009

(57) ABSTRACT

Systems, methods, devices, and computer program products are provided for creating chapters in recorded continuous media data at the time that the continuous media data is being recorded. More particularly, while recording continuous media data, a user may instruct the processor of a recording device to create a chapter at a particular location in the continuous media data by actuating a user input device during the recording of the continuous media data.

### FIELD OF EMBODIMENTS OF THE INVENTION

Embodiments of the invention relate generally to recording and editing continuous media data, such as audio or video data. More particularly, embodiments of the invention relate to systems, methods, devices, and computer program products for creating chapters in continuous media data while recording the continuous media data.

### BACKGROUND OF EMBODIMENTS OF THE INVENTION

As video and audio recording systems continually become smaller and less-expensive and as data storage systems likewise become smaller and less-expensive, users will continue to capture and share increasing amounts of video and audio data. Problems arise when a user attempts to navigate the video and/or audio data and attempts to find a particular video or audio segment in the video or audio data. For example, a user with a handheld video camera device may capture several hours of video. The video, however, may include video segments of several different events. In order for the user to find the video segment containing video of one particular event, the user must typically fast-forward or rewind through the video in search of the desired video sequence. It would, therefore, be desirable if, during playback of the video or when editing the video, the user could quickly locate a particular video sequence by jumping directly to the beginning of the desired video sequence. For example, a wedding videographer may desire to produce a recording that allows him or her to easily locate the video segment for each event during a wedding, such as the wedding ceremony, the toast, the cake cutting, etc.

Currently, a number of software applications allow a user to add chapters to already-recorded video files. For example, after a user records a video, the user can transfer a digital video file to a computer. The user can then use a video post-processing software application on the computer to browse the digital video file and add chapters wherever the user chooses in the video. The chapters can allow the user to quickly jump to particular locations in the video. This can be considerably time consuming since the user must search through the video or watch the video in order to find the places in the video where chapters should be inserted.

### BRIEF SUMMARY OF EMBODIMENTS OF THE INVENTION

In light of the foregoing background, exemplary embodiments of the present invention provide a system, method, device, and computer program product that allows a user to record continuous media data (e.g., video and/or audio data) and, at the same time, create chapters for the recorded continuous media data.

In one embodiment, a recording device is provided having a memory device configured to store media data therein; a data communication interface for receiving continuous media data; a user input device configured to allow a user to enter user input; and a processor operatively coupled to the user input device, the data communication interface, and the memory device. The processor may be configured to record the continuous media data in the memory device. The processor may be further configured to receive the user input from the user input device while recording the continuous media data. The processor may also be configured to record chapter information in the memory device based on the user input, where the chapter information comprises location information about a location of a chapter in the continuous media data.

The recording device may further include a data capture device configured to capture the continuous media data. The data communication interface may be configured to receive the continuous media data from the data capture device. The data capture device may include an image capture device configured to capture video data.

The recording device may have a user output interface configured to present the continuous media data to the user while the processor is recording the continuous media data in the memory device. The user output device may include a display for displaying the continuous media data to the user. The processor may be configured to record chapter information for a location in the continuous media data that substantially coincides with the location in the continuous media data presented via the user output interface at the time that the user input device is actuated.

Actuation of the user input device may signify the beginning or ending of a chapter, and the chapter information may include a chapter indicator for indicating the starting point or ending point of a particular portion of the continuous media data. The chapter information may include annotation information for the portion of the continuous media data, and the annotation information may include a chapter title. The processor may be configured to access customizable information stored in the memory device and base the annotation information at least partially on the customizable information. The user input device may include a microphone and the processor may be configured to base the annotation information at least partially on audio information received from the microphone for a limited period of time after the user input is entered. The processor may be configured to provide the user with a menu of different annotation information choices using a user output interface after the user input is entered.

Actuation of the user input device may instruct the processor to begin or resume recording the continuous media data to the memory device and record chapter information for the location in the continuous media data where the processor begins or resumes recording. The processor may be configured to record chapter information in a file location separate from the file location of the continuous media data, and the chapter information may include location information about the location in the continuous media data of the beginning point or ending point of at least one portion of the continuous media data.

In another embodiment of the present invention, a method is provided including: receiving continuous media data; recording the continuous media data in a memory device; receiving user input while recording the continuous media data; and recording chapter information in the memory device based on the user input, where the chapter information comprises location information about a location of a chapter in the continuous media data. The method may further include capturing the continuous media data, and/or presenting the continuous media data to the user while the processor is recording the continuous media data in the memory device. Recording chapter information may involve recording chapter information for a location in the continuous media data that substantially coincides with the location in the continuous media data presented at the time that the user input is received. The receipt of the user input may signify the beginning or ending of a chapter, and the recording chapter information may involve recording a chapter indicator for indicating the starting point or ending point of a particular portion of the continuous media data.

Recording chapter information may include recording a chapter title. Recording a chapter title may involve accessing customizable information stored in the memory device and basing the chapter title at least partially on the customizable information. Receiving user input may instruct a processor to: begin or resume recording the continuous media data to the memory device, and record chapter information for the location in the continuous media data where the processor begins or resumes recording.

In another embodiment of the present invention, a computer program product is provided for creating chapters for continuous media data while recording the continuous media data. The computer program product includes a computer-readable storage medium having computer-readable program code portions stored therein. The computer-readable program code portions may include: a first executable portion for receiving continuous media data; a second executable portion for recording the continuous media data in a memory device; a third executable portion for receiving user input while recording the continuous media data; and a fourth executable portion for recording chapter information in the memory device based on the user input, where the chapter information comprises location information about a location of a chapter in the continuous media data.

The computer program product may further include a fifth executable portion for presenting the continuous media data to the user while the processor is recording the continuous media data in the memory device. The fourth executable portion may be configured to record chapter information for a location in the continuous media data that substantially coincides with the location in the continuous media data presented at the time that the user input is received. The fourth executable portion may be further configured to record chapter information for indicating the starting point or ending point of a particular portion of the continuous media data.

The fourth executable portion may be configured to record a chapter title and may be configured to access customizable information stored in the memory device and base the chapter title at least partially on the customizable information. The second executable portion may be configured to begin or resume recording the continuous media data to the memory device based on user input and the fourth executable portion may be configured to record chapter information for the location in the continuous media data where the processor begins or resumes recording.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system for recording continuous media data with chapter information, in accordance with one embodiment of the present invention;

FIG. 2 is a schematic block diagram of a processing element of the system of FIG. 1, in accordance with one embodiment of the present invention;

FIG. 3 is a flowchart illustrating a method of creating chapters for continuous media data, in accordance with one embodiment of the present invention;

FIG. 4 is a flowchart illustrating a method of creating chapters for continuous media data, in accordance with another embodiment of the present invention;

FIG. 5 is a flowchart illustrating a method of creating chapters for continuous media data, in accordance with yet another embodiment of the present invention;

FIG. 6 is a flowchart illustrating a method for generating chapter titles, in accordance with one embodiment of the present invention;

FIG. 7 is a flowchart illustrating a method for generating chapter titles, in accordance with another embodiment of the present invention;

FIG. 8 is a flowchart illustrating a method for generating chapter titles, in accordance with yet another embodiment of the present invention;

FIG. 9 is a flowchart illustrating a method for generating chapter titles, in accordance with yet another embodiment of the present invention; and

FIG. 10 is a schematic block diagram of an electronic device that may benefit from embodiments of the present invention.

### DETAILED DESCRIPTION OF EMBODIMENTS OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The system, method, device, and computer program product of exemplary embodiments of the present invention are, at times, described herein without respect to the environment within which the system, method and computer program product operate. It should be understood, however, that the system, method, device, and computer program product may operate in a number of different environments, including mobile and/or fixed environments, wireline and/or wireless environments, standalone and/or networked environments, or the like. For example, the system, method, device, and computer program product of exemplary embodiments of the present invention can operate in mobile communication environments whereby mobile terminals operating within one or more mobile networks include or are otherwise in communication with one or more sources of continuous media data.

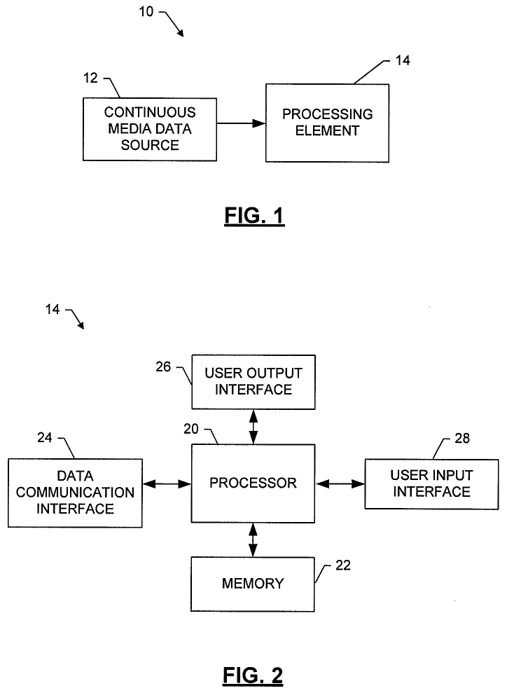

Referring to FIG. 1, an illustration is provided of one system that would benefit from embodiments of the present invention. The system 10 includes a continuous media data source 12 and a processing element 14. For purposes of this application, continuous media data may include, for example, video data and/or audio data. Where the continuous media data comprises video data, each sequence of video data provided by the video data source may include a plurality of frames. The continuous media data source 12 may comprise any of a number of different entities capable of providing one or more sequences of continuous media data to the processing element 14. In this regard, in one embodiment of the present invention, the continuous media data source 12 includes an image capture device, such as a digital camera module, for capturing video data and/or a microphone for capturing audio data.

In another embodiment of the present invention, the continuous media data source 12 includes a system or device for providing streaming continuous media data to the processing element 14 via a communication network. In this regard, the continuous media data source 12 may comprise a media or content server for transmitting media data via a television network, a cable network, a radio network, the Internet, or the like, or some other system or device capable of providing streaming continuous media data to the processing element 14.

The processing element 14 is operatively coupled to the continuous media data source 12 and receives continuous media data from the continuous media data source 12. The processing element 14 may comprise any of a number of different entities capable of processing continuous media data received from the continuous media data source 12 by recording the continuous media data to a memory and recording chapter information for the continuous media data, as explained below. In this regard, the processing element 14 may comprise, for example, a video cassette recorder (VCR), a DVD recorder, a digital video recorder (DVR), a radio cassette recorder, a CD recorder, a laptop or desktop computer, or the like.

Although shown as separate entities in FIG. 1, it should be understood that, in some embodiments, a single entity may support both the continuous media data source 12 and the processing element 14. For example, a mobile terminal may support a logically separate, but co-located, continuous media data source 12 (e.g., a video camera and/or a microphone) and processing element 14. Other examples of devices where the continuous media data source 12 and the processing element 14 may be co-located include a hand-held video camera, a dictating machine, and the like.

The continuous media data source 12 may be capable of providing one or more continuous media data sequences in a number of different continuous media data formats. The continuous media data received by the processing element 14 may be in an analog or digital form. Likewise, the processing element 14 may be configured to record, encode, and/or compress the continuous media data using a number of different formats and standards. For example, formats for storing or streaming continuous media data may include AVI (Audio Video Interleave), ASF (Advanced Streaming Format), Matroska, and the like. Formats for encoding and/or compressing continuous media data (e.g., audio and video data) may include MPEG (Moving Pictures Expert Group) such as MPEG-2 or MPEG-4, M-JPEG (Motion JPEG), DivX;-), XviD, Third Generation Platform (3GP), AVC (Advanced Video Coding), AAC (Advanced Audio Coding), Windows Media® (WMV), QuickTime® (MOV), RealVideo®, Shockwave® (Flash®), DVD-Video, DVD-Audio, Nero Digital, MP3 (MPEG-1), Musepack (MP+), Ogg, OGM, WAV, PCM, Dolby Digital (AC3), AIFF (Audio Interchange File Format), or the like.

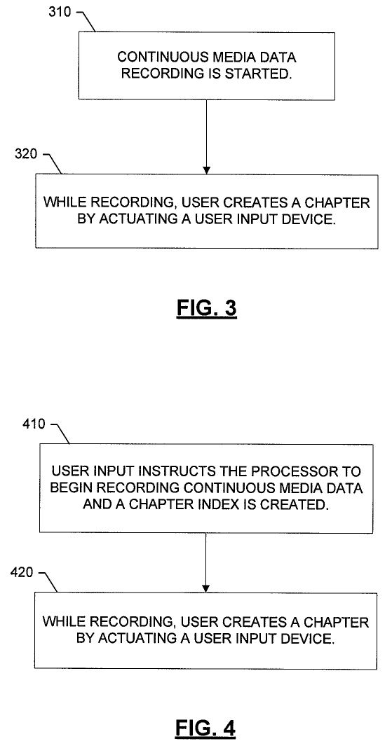

Referring now to FIG. 2, a block diagram of an entity capable of operating as a processing element 14 is shown in accordance with one exemplary embodiment of the present invention. As shown and described herein, the processing element 14 may be embodied in, for example, a video recording device, an audio recording device, a personal computing (PC) device such as a desktop or laptop computer, a media center device or other PC derivative, a personal video recorder, portable media consumption device (mobile terminal, personal digital assistant (PDA), gaming and/or media console, etc.), dedicated entertainment device, television, digital television set-top box, radio device or other audio playing device, other consumer electronic device, or the like. As shown, the processing element 14 includes various systems for performing one or more functions in accordance with exemplary embodiments of the present invention, including those systems more particularly shown and described herein. It should be understood, however, that the processing element 14 may include alternative systems for performing one or more like functions.

As shown in FIG. 2, the processing element 14 can include a processor 20 operatively coupled to a memory 22. The memory 22 can comprise volatile and/or non-volatile memory, and typically stores content, data, or the like. For example, the memory 22 can store client applications, instructions, or the like for the processor 20 to perform steps associated with operation of the entity in accordance with exemplary embodiments of the present invention. Also, for example, the memory 22 can store one or more continuous media data sequences, such as those received from the continuous media data source 12. As is described below, to facilitate navigation of one or more of those sequences (or other purposes described herein), the memory 22 can further store chapter information therein. The memory 22 may be fixed or removable. The memory device 22 may include a hard drive, a CD, a DVD, a Blu-ray disk, a memory card such as a Flash memory card, a Memory stick, a Secure Digital (SD) card and the like, a video tape cassette, an audio tape cassette, and the like.

As described herein, the client application(s), instructions, or the like may comprise software operated by the processing element 14. It should be understood, however, that any one or more of the client applications described herein can alternatively comprise firmware or hardware, without departing from the spirit and scope of the present invention. Generally, then, the processing element can include one or more logic elements for performing various functions of one or more client application(s), instructions or the like. As will be appreciated, the logic elements can be embodied in any of a number of different manners. In this regard, the logic elements performing the functions of one or more client applications, instructions or the like can be embodied in an integrated circuit assembly including one or more integrated circuits integral or otherwise in communication with the processing element or more particularly, for example, the processor 20 of the processing element 14. The design of integrated circuits is by and large a highly automated process. In this regard, complex and powerful software tools are available for converting a logic level design into a semiconductor circuit design ready to be etched and formed on a semiconductor substrate. These software tools automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the memory 22, the processor 20 can also be operatively coupled to at least one interface or other means for displaying, transmitting and/or receiving data, content or the like. In this regard, the interface(s) can include at least one data communication interface 24 or other means for receiving continuous media data from the continuous media data source 12. The data communication interface 24 is configured to be operatively coupled to the continuous media data source 12. As described above, the continuous media data source 12 may be part of the same device that the processing element 14 is included in. As such, the continuous media data source 12 may be coupled to the data communication interface 24 via a wire or other electrical contact and may even be integrated together. In other embodiments, the continuous media data source 12 is a separate entity from the data communication interface 24 and the two entities may be coupled by a communication network. In such an embodiment, the communication network may comprise a wireless, wireline, or combination wireless-wireline network. The communication network may be a local area network (LAN), a metropolitan area network (MAN), and/or a wide area network (WAN). The data communication interface 24 may comprise a receiver for receiving continuous media data and may comprise one or more encoders, decoders, and/or converters so that the continuous media data received from the continuous media data source 12 can be encoded, decoded, or otherwise converted to a form that the processor 20 can recognize.

In addition to the communication interface 24, the interface(s) may also include at least one user output interface 26 that may include one or more earphones and/or speakers, a display, or the like. The user output interface 26 may present to a user the continuous media data received from the continuous media source 12 (via the media communication interface 24). In particular, the processor 20 may be configured to present the continuous media data to the user using the user output interface 26 at approximately the same time that the processor 20 is recording the continuous media to the memory 22. For example, the processor 20 may be configured to have a first processing component or a portion of the processing power directed to presenting the received continuous media data using the user output interface 26 while a second processing component or another portion of the processing power is directed to recording the continuous media data to the memory 22. In another embodiment, the processor 20 may be configured to first record the continuous media data to the memory 22 and then present the continuous media data using the user output interface 26 immediately thereafter, so that the continuous media being presented is slightly delayed behind the continuous media being recorded. In yet another embodiment, the processor 20 may be configured to first present the continuous media data using the user output interface 26 and then record the continuous media to the memory 22 immediately thereafter, so there is a slight delay between the continuous media being presented via the user output interface 26 and the continuous media being recorded to the memory 22. Before the continuous media data is presented using the user output interface 26, the processor 20 may decode or otherwise convert the continuous media data to an analog form or to a digital form that the user output interface 26 is configured to utilize.

The interface(s) may also include at least one user input interface 28. The user input interface 28 may comprise any of a number of user input devices allowing the entity to receive commands or other data from a user, such as a microphone, a key, a keypad, a touch display, a joystick, or other user input device. The user input interface 28 is generally configured to allow the user to command the processor to start and stop the recording of continuous media data.

Embodiments of the present invention provide systems, methods, devices, and computer program products that create chapters for continuous media data recordings at the time that the continuous media data is being recorded. More particularly, embodiments of the invention record chapter information based on user input entered while the user is recording the continuous media data. It should be appreciated that embodiments of the present invention may allow a user to create chapters in a recording in a more convenient way than using the post-processing software applications. For example, a user of one embodiment of the invention may be recording a birthday party and may create a plurality of chapters in the video for each event at the birthday party, such as a chapter for blowing out candles and a chapter for opening gifts. The user may create such chapters by simply pressing a button on the video camera at the time that each event begins during the recording of the party. In another example, a user recording a baseball game using a DVD recorder can create a chapter for each inning by simply pressing a button on the DVD recorder or the associated remote control at the start of each inning when the user is recording the game. In yet another example, a reporter interviewing a plurality of people at an event can press a button on the audio recorder while recording in order to create different chapters for each person interviewed. The above examples provide examples of only some potential uses of several embodiments of the present invention. Other uses and other embodiments of the present invention will be described in greater detail below or will be apparent to one of ordinary skill in the art in view of this disclosure.

Chapter information may be recorded and associated with a continuous media data recording in a variety of different ways. Often, the file format or container format that is used to record the continuous media data determines how chapters should be recorded and associated with the continuous media data. In one embodiment, the continuous media data is recorded in a container format, the container comprising a plurality of data streams or files. In such an embodiment, the continuous media data may be recorded such that one or two data streams or files contain the audio and/or video data, while another data stream or file comprises chapter information. For example, in one embodiment, the continuous media data source 12 sends video and audio data streams to the processor 20. The processor 20 may then encode the incoming video stream into an MPEG-2 format and encode the audio stream into AC3 format and store these streams in the memory 22. The processor 20 may then record chapter information into a separate file in the memory 22. The audio, video, and chapter information files may then be used in component form or two or more of the files may be multiplexed into a single file or container.

In such an embodiment, the format of the chapter information file may depend on the file formats used for the video and/or audio streams, and/or may depend on the decoder, multiplexer, or other application that is to process the different files. Generally, the chapter information file will include a chapter title or other ID and a chapter location, such as a particular frame or time in the continuous media data recording. In these types of chapter systems where the processor 20 records chapter information into a separate data file from the file(s) containing the continuous media data, the processor may be configured to record such data in the appropriate data file generally in parallel with the recording of the continuous media data, or the processor may keep the chapter information in a buffer memory and store the chapter information to the appropriate data file at the end of the recording of the continuous media data.

In one exemplary embodiment, the chapter information may be recorded into a .IFO (Information) file on a DVD. The IFO file is recorded to the DVD along with one or more video objects (VOBs), having multiplexed audio and video streams. In such an embodiment, the chapter information may include location information by reference to a particular frame or by reference to a time (e.g., hours: minutes: seconds: milliseconds) after some reference time in the recorded continuous media data (e.g., time 0 at the beginning of the recording). In another example, chapter information may be created in an MPEG-4-type format by including at least a chapter name and chapter location information in the User Data Atom (udta) file.

In yet another example, the continuous media data is stored in a Matroska-type container. Where chapters are to be inserted for the following continuous media data segments (defined in terms of milliseconds) and having the following titles:
00000 ms-05000 ms: Intro
05000 ms-25000 ms: Act 1
25000 ms-27500 ms: Act 2,
   the chapter information in Matroska form for the above exemplary chapters may be:

| | |
|---|---|
| Chapters | |
| EditionEntry | |
| ChapterAtom | |
| ChapterUID | 0x123456 |
| ChapterTimeStart | 0 ns |
| ChapterTimeEnd | 5,000,000 ns |
| ChapterDisplay | |
| ChapterString | Intro |
| ChapterLanguage | eng |
| ChapterAtom | |
| ChapterUID | 0x234567 |
| ChapterTimeStart | 5,000,000 ns |
| ChapterTimeEnd | 25,000,000 ns |
| ChapterDisplay | |
| ChapterString | Act 1 |
| ChapterLanguage | eng |
| ChapterAtom | |
| ChapterUID | 0x345678 |
| ChapterTimeStart | 25,000,000 ns |
| ChapterTimeEnd | 27,500,000 ns |
| ChapterDisplay | |
| ChapterString | Act 2 |
| ChapterLanguage | eng. |

In other embodiments of the invention, chapter information is recorded directly into the audio or video data streams. For example, the processing element may be configured to record a machine-recognizable indicator into a frame of a video stream or a portion of an audio stream. The playback device or an application may then be capable of recognizing the indicator so that the device or application can jump to the point in the video or audio data streams where the indicator is located.

In other embodiments of the present invention, still other systems for storing chapter information and associating the chapter information with the continuous media data may be used. Such other systems will be apparent to one of ordinary skill in the art in view of this disclosure.

In general, the chapter information will include location information providing at least an approximate location in the continuous media data for the beginning or the end of a chapter. For example, the chapter location information may comprise a particular frame that marks the beginning of a new chapter. In another example, the chapter location may comprise a particular time that marks the beginning of a new chapter, the time being relative to the beginning of the recording or relative to some other reference time. The application and/or device configured to process the continuous media data along with any associated chapter information can use the location information to automatically jump to the stated location in the continuous media data. The chapter information may also include other information such as chapter annotation information, which may include a chapter title or other chapter ID, a chapter description, and the like.

FIG. 3 is a flowchart illustrating a method of creating chapters for continuous media data, in accordance with one embodiment of the present invention. As represented by block 310, the continuous media data recording is started. For example, a user of a recording device may actuate a user input device in order to begin recording the continuous media data. In one embodiment, a designated “record key” is provided in the user interface that the user can actuate to instruct the processor to begin recording the continuous media data.

As represented by block 320, while the processor is recording the continuous media data, actuation of a user input device may instruct the processor to record chapter information. In one embodiment, the continuous media is presented to the user using a user input interface. Upon actuation of the user input device, the processor may record a chapter indicator at approximately the location in the continuous media data that was being presented to the user at the time the user actuated the user input device. The user input device used to instruct the processor to create a chapter may be a key dedicated just for creating a chapter, may be the record key, or may be some other key or user input device. In one embodiment, a record key is used to: begin recording when the recording device is in a non-recording state; create a chapter when the recording device is in a recording state and when the key is pressed for a brief amount of time; and stop recording when the recording device is in a recording state and when the record key is pressed and held for a longer amount of time. In other embodiments, a different user input device, such as a “stop” button, is used to stop recording the continuous media data.

In one embodiment, the record key is used to stop recording when the recording device is in a recording state and when the record key is pressed for a brief amount of time and the recording device is used to create a chapter when the recording device is in a recording state and when the key is pressed and held for a longer amount of time. In such an embodiment, the recording device may be further configured to record voice input during the time that the record button is pressed and held for the longer amount of time. In this way, the voice input may be stored as a chapter title or other chapter annotation information for the next chapter or, in some embodiments, the preceding chapter.

FIG. 4 is a flowchart illustrating a method of creating chapters for continuous media data, in accordance with another embodiment of the present invention. As represented by block 410, the user may actuate a user input device in order to instruct the processor to begin recording continuous media data. In response to the user input, the processor both begins recording the continuous media data and creates a new chapter indicator for the beginning of the recording. While the continuous media data is being recorded, the user may be able to actuate a user input device in order to create additional chapters in the recorded media, as represented by block 420.

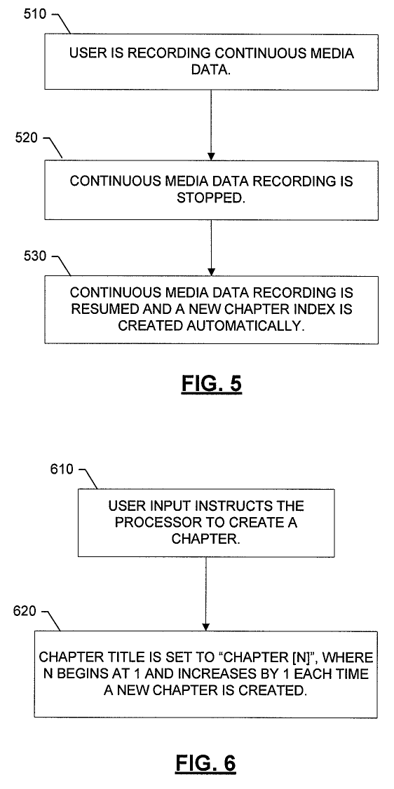

As illustrated in FIG. 5, in one embodiment of the present invention, chapter information may also be created when the recording of continuous media data is resumed after having been stopped. More particularly, continuous media data may be recorded and the recording may be, at times, stopped by the user, as represented by blocks 510 and 520. Where the user is not finished recording the continuous media data and only stopped the recording temporarily, then a new chapter may be generated by the processor in response to user input instructing the processor to resume recording of the continuous media data. Either automatically or at the user's option, the processor may then create a chapter located in relation to the recorded continuous media data at the place where recording was resumed, as represented by block 530.

For example, in one embodiment of the present invention, a user is recording video data using a digital video camera configured in accordance with one embodiment of the invention. The video camera includes a display for displaying where the camera is directed when the camera is not recording video and for displaying what is being recorded when the camera is recording video. The user may actuate a record button on the camera in order to instruct the camera to begin recording. In response to the user input, in addition to beginning to record, the camera may create a chapter indicator located at the first frame in the recording. The camera may create the chapter indicator by storing a chapter name and the chapter location in a chapter information record associated with the recorded continuous media data. While the camera is recording, the user may create additional chapters by simply pressing the record button. In response to this user input, the camera creates additional chapter indicators by storing new chapter names and chapter locations in the chapter information file. The chapter location may be determined as the approximate location in the continuous media content that corresponds to what was being displayed on the camera's display at the time that the user actuated the record button to indicate the creation of a new chapter. The user may stop the recording by, for example, holding the record button down for several seconds. If the user only temporarily stopped the recording, then the camera may create a new chapter, either automatically or at the user's option, in response to the user pressing the record button again to resume recording the continuous media data.

As described above, in one embodiment, the chapter information includes a chapter title for one or more of the chapters. FIG. 6 is a flowchart illustrating how chapter titles may be created in accordance with one embodiment of the present invention. As described above, and as represented by block 610, during the recording of continuous media content the user instructs the processor to create a chapter, either directly by actuating a particular user input device for creating chapters or indirectly by instructing the processor to begin or resume recording of continuous media data. In the illustrated embodiment, chapter titles are automatically generated each time a new chapter is created. As represented by block 620, the chapter title may be automatically stored as “Chapter [n]” where n initially is equal to one and increases by a value of one each time a new chapter is generated. In this regard, the first chapter created would be called “Chapter 1,” the second chapter would be called “Chapter 2,” and so forth. In other embodiments, only increasing numerals or consecutive letters in the alphabet are used as the titles for the consecutive chapters. In other embodiments, the title may not begin with “Chapter” and, in one embodiment, may begin with a word or phrase specified by the user.

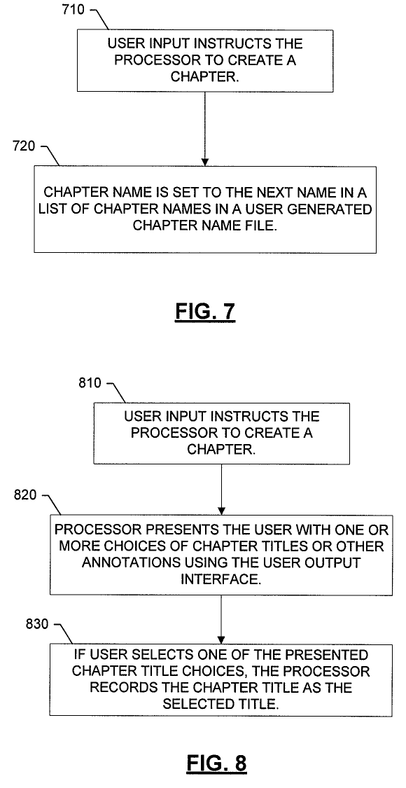

In other embodiments, the user may have greater control of the chapter titles and can create customized titles. For example, in the embodiment illustrated in FIG. 7, the user creates a list of titles and stores the list of titles in the memory of the processing element. Each time the user input instructs the processor to create a new chapter, as represented by block 710, the processor accesses the user's list stored in the memory and records a chapter title based on information in the list. For example, the processor may be configured to use the first title in the list as the first chapter title. The processor may then use the second title in the list as the second chapter title, and so forth, until all of the titles in the list are used. Such an embodiment may be useful where the user knows the order of recorded events in advance of recording. For example, if a user recording a video of a band knows the order of songs that the band will play in advance of recording the actual event, the user could enter the list of song titles into the camera memory prior to recording the event. While recording, the user simply has to actuate a user input device between each song that the band plays in order for the video camera to create a chapter for each song, each chapter being titled as the name of the song.

FIG. 8 is a flowchart illustrating how chapter titles may be generated in accordance with another embodiment of the present invention. In particular, in the embodiment of FIG. 8, after the user input instructs the processor to create a new chapter, as represented by block 810, the processor presents the user with a menu of possible chapter titles using the user output interface, as represented by block 820. The menu of possible chapter titles may include user defined titles and/or standard or otherwise computer-generated titles. As represented by block 830, when the menu is presented to the user, the user can actuate a user input device to select one of the titles in the menu, which the processor then uses as the current chapter title.

Such an embodiment may be useful where the user knows the events that are likely to take place, but the user does not necessarily know the sequence of the events. For example, in one embodiment, the user of a video camera provides the camera with a list of chapter titles that the user feels will likely be used to represent segments in a continuous media data recording that the user is going to record. When the user is recording the continuous media data and instructs the camera to create a chapter, the camera displays a menu of chapter titles having the chapter titles from the list that the user provided to the camera. The user can then select one of these titles from the menu to be recorded by the processor as the current chapter title.

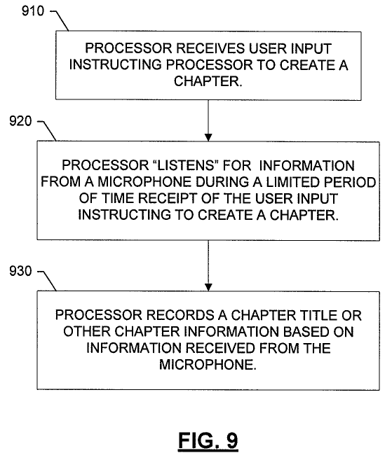

FIG. 9 is a flowchart illustrating yet another method for creating chapter titles, in accordance with one embodiment of the present invention. In this embodiment, after the processor receives instructions to create a chapter, as represented by block 910, the processor “listens” for information received from a microphone, as represented by block 920. The processor does this for a limited period of time immediately after the user instructs the processor to create a new chapter. In this way, a user can speak a title or a description of the upcoming chapter into the microphone and the processor can either record an audio title or description with the chapter information or the processor can use voice recognition software to generate a text-based chapter title or description for the new chapter. As described above, in another embodiment, the user can hold down the record key or actuate some other user input device in order to enter chapter information via the microphone. In one embodiment, the information received from the microphone is used to create a chapter and/or other annotation information for the previous chapter instead of for the upcoming chapter. In such an embodiment, the recording device may automatically pause recording to allow for entering of chapter information. In other embodiments, the user could similarly provide the chapter information by means of a keypad or other input device.

Once the chapters are created, the chapters may be used to generate a table of contents or other menu-type display of the chapters in the recorded continuous media data. In one embodiment, the processor generates a menu in which thumbnail images from the chapter or even portions of the continuous media data from each chapter are displayed in such a menu. In one embodiment of the present invention, the user can select an image or a portion of continuous media to use in this regard by actuating a particular user input device during the recording of the continuous media data. The thumbnail or the continuous media portion may be then recorded as chapter information or the location (e.g., the frame or range of frames) of the thumbnail or the continuous media portion can be recorded as chapter information. In other embodiments the first frame or the first several seconds of each chapter is used as the thumbnail image or the continuous media portion, respectively.

Although several different functions and methods are described above for allowing a user to create chapters, chapter titles, and other annotations for recorded continuous media data while recording the continuous media data, various combinations of these different functions and methods may be available in the same device or system, in accordance with one embodiment of the present invention. In one embodiment, the device or system allows the user to select from several different functions or methods of creating the chapters, chapter titles, and other annotations for the continuous media data.

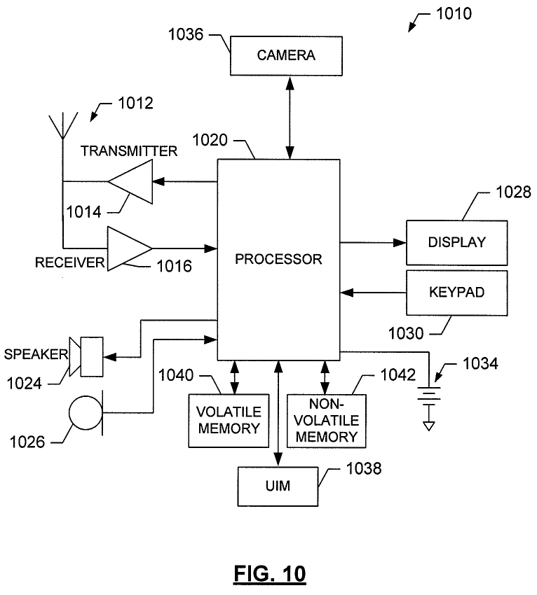

In one embodiment of the present invention, the above described systems and methods, or a portion of the above described systems and methods, may be implemented using an electronic device, and in particular, a mobile terminal. FIG. 10 illustrates a block diagram of an electronic device, and specifically a mobile terminal 1010, that may comprise the continuous media data source and/or the processing element, in accordance with embodiments of the present invention. While several embodiments of the mobile terminal 1010 are illustrated and will be hereinafter described for purposes of example, other types of electronic devices, such as digital cameras, including digital still image cameras and digital video cameras, portable digital assistants (PDAs), pagers, mobile televisions, computers, laptop computers, and other types of systems that manipulate and/or store data files, can readily employ embodiments of the present invention. Such devices may or may not be mobile.

The mobile terminal 1010 includes a communication interface comprising an antenna 1012 in operable communication with a transmitter 1014 and a receiver 1016. The mobile terminal 1010 further includes a processor 1020 or other processing element that provides signals to and receives signals from the transmitter 1014 and receiver 1016, respectively. The signals include signaling information in accordance with the air interface standard of the applicable cellular system, and also user speech and/or user generated data. In this regard, the mobile terminal 1010 is capable of operating with one or more air interface standards, communication protocols, modulation types, and access types. By way of illustration, the mobile terminal 1010 is capable of operating in accordance with any of a number of first, second and/or third-generation communication protocols or the like. For example, the mobile terminal 1010 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the processor 1020 includes circuitry required for implementing audio and logic functions of the mobile terminal 1010 including those described above in conjunction with the addition of chapter information while continuously recording media such as those depicted in FIGS. 3-9. For example, the processor 1020 may be comprised of a digital signal processor device, a microprocessor device, and various analog to digital converters, digital to analog converters, and other support circuits. Control and signal processing functions of the mobile terminal 1010 are allocated between these devices according to their respective capabilities. The processor 1020 thus may also include the functionality to convolutionally encode and interleave message and data prior to modulation and transmission. The processor 1020 can additionally include an internal voice coder, and may include an internal data modem. Further, the processor 1020 may include functionality to operate one or more software programs, which may be stored in memory. For example, the processor 1020 may be capable of operating a connectivity program, such as a conventional Web browser. The connectivity program may then allow the mobile terminal 1010 to transmit and receive Web content, such as location-based content, according to a Wireless Application Protocol (WAP), for example.

The mobile terminal 1010 also comprises a user interface including an output device such as a conventional earphone or speaker 1024, a microphone 1026, a display 1028, and a user input interface, all of which are coupled to the processor 1020. The display 1028 may display chapter options and/or video while recording. The user input interface, which allows the mobile terminal 1010 to receive data, may include any of a number of devices allowing the mobile terminal 1010 to receive data, such as a keypad 1030, a touch display (not shown) or other input device, and may serve as a user input device for denoting the location of chapters or for use in naming chapters or designating thumbnail or preview images. In embodiments including the keypad 1030, the keypad 1030 may include the conventional numeric (0-9) and related keys (#, *), and other keys used for operating the mobile terminal 1010. Alternatively, the keypad 1030 may include a conventional QWERTY keypad. The mobile terminal 1010 further includes a battery 1034, such as a vibrating battery pack, for powering various circuits that are required to operate the mobile terminal 1010, as well as optionally providing mechanical vibration as a detectable output.

In an exemplary embodiment, the mobile terminal 1010 includes a camera 1036 in communication with the processor 1020. The camera 1036 may be any means for capturing an image for storage, display or transmission. For example, the camera 1036 may include a digital camera capable of forming a digital image file from a captured image. As such, the camera 1036 includes all hardware, such as a lens or other optical device, and software necessary for creating a digital image file from a captured image. In an exemplary embodiment, the camera 1036 may further include a processing element such as a co-processor which assists the processor 1020 in processing image data and an encoder and/or decoder for compressing and/or decompressing image data. The encoder and/or decoder may encode and/or decode according to a JPEG standard format. The camera 1036 may be responsive to a record button that can serve as the user input device as described above.

The mobile terminal 1010 may further include a user identity module (UIM) 1038. The UIM 1038 is typically a memory device having a processor built in. The UIM 1038 may include, for example, a subscriber identity module (SIM), a universal integrated circuit card (UICC), a universal subscriber identity module (USIM), a removable user identity module (R-UIM), etc. The UIM 1038 typically stores information elements related to a mobile subscriber. In addition to the UIM 1038, the mobile terminal 1010 may be equipped with memory. For example, the mobile terminal 1010 may include volatile memory 1040, such as volatile Random Access Memory (RAM) including a cache area for the temporary storage of data. The mobile terminal 10 may also include other non-volatile memory 1042, which can be embedded and/or may be removable. The non-volatile memory 1042 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 1010 to implement the functions of the mobile terminal 1010. For example, the memories can include an identifier, such as an international mobile equipment identification (IMEI) code, capable of uniquely identifying the mobile terminal 1010.

The functions described above with respect to the various embodiments of the present invention may be carried out in many ways. For example, any suitable means for carrying out each of the functions described above may be employed to carry out embodiments of the invention. According to one aspect of the present invention, all or a portion of the system of the present invention generally operates under control of a computer program product. The computer program product for performing the various processes and operations of embodiments of the present invention includes a computer-readable storage medium, such as a non-volatile storage medium, and computer-readable program code portions, such as a series of computer instructions, embodied in the computer-readable storage medium. For example, in one embodiment, the processor of one or more electronic devices generally operate under the control of a computer program product to execute a chapter creating application in order to perform the various functions described above with reference to creating chapters for continuous media recordings while recording the continuous media data.

In this regard, FIGS. 3-9 are flowcharts or block diagrams of operations performed by methods, systems, devices, and computer program products according to embodiments of the present invention. It will be understood that each block of a flowchart or each step of a described method can be implemented by computer program instructions. These computer program instructions may be loaded onto a computer or other programmable apparatus to produce a machine, such that the instructions which execute on the computer or other programmable apparatus create means for implementing the functions specified in the described block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the described block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the described block(s) or step(s).

It will also be understood that each block or step of a described herein, and combinations of blocks or steps, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A recording device comprising:
a memory device configured to store media data therein;
a data communication interface for receiving continuous media data;
a user input device configured to allow a user to enter user input; and
a processor operatively coupled to the user input device, the data communication interface, and the memory device; wherein the processor is configured to record the continuous media data in the memory device; wherein the processor is further configured to receive the user input from the user input device while recording the continuous media data and record chapter information in the memory device based on the user input; and wherein the chapter information comprises location information about a location of a chapter in the continuous media data.

2. The recording device of claim 1, further comprising:
a data capture device configured to capture the continuous media data, wherein the data communication interface is configured to receive the continuous media data from the data capture device.

3. The recording device of claim 2, wherein the data capture device comprises an image capture device configured to capture video data.

4. The recording device of claim 1, further comprising:
a user output interface configured to present the continuous media data to the user while the processor is recording the continuous media data in the memory device.

5. The recording device of claim 4, wherein the user output device comprises a display for displaying the continuous media data to the user.

6. The recording device of claim 4, wherein the processor is configured to record chapter information for a location in the continuous media data that substantially coincides with the location in the continuous media data presented via the user output interface at the time that the user input device is actuated.

7. The recording device of claim 6, wherein actuation of the user input device signifies the beginning or ending of a chapter, and wherein the chapter information comprises a chapter indicator for indicating the starting point or ending point of a particular portion of the continuous media data.

8. The recording device of claim 1, wherein the chapter information comprises a chapter indicator for indicating the starting point or ending point of a particular portion of the continuous media data.

9. The recording device of claim 8, wherein the chapter information comprises annotation information for the portion of the continuous media data.

10. The recording device of claim 8, wherein the annotation information comprises a chapter title.

11. The recording device of claim 9, wherein the processor is configured to access customizable information stored in the memory device and base the annotation information at least partially on the customizable information.

12. The recording device of claim 9, wherein the user input device comprises a microphone and wherein the processor is configured to base the annotation information at least partially on audio information received from the microphone for a limited period of time after the user input is entered.

13. The recording device of claim 9, further comprising a user output interface, wherein the processor is configured to provide the user with a menu of different annotation information choices using the user output interface after the user input is entered.

14. The recording device of claim 1, wherein actuation of the user input device instructs the processor to begin or resume recording the continuous media data to the memory device and record chapter information for the location in the continuous media data where the processor begins or resumes recording.

15. The recording device of claim 1, wherein the processor is configured to record chapter information in a file location separate from the file location of the continuous media data, and wherein the chapter information comprises location information about the location in the continuous media data of the beginning point or ending point of at least one portion of the continuous media data.

16. A method comprising:
receiving continuous media data;
recording the continuous media data in a memory device;
receiving user input while recording the continuous media data; and
recording chapter information in the memory device based on the user input; wherein the chapter information comprises location information about a location of a chapter in the continuous media data.

17. The method of claim 16, further comprising:
capturing the continuous media data.

18. The method of claim 16, further comprising:
presenting the continuous media data to the user while the processor is recording the continuous media data in the memory device.

19. The method of claim 18, wherein recording chapter information comprises recording chapter information for a location in the continuous media data that substantially coincides with the location in the continuous media data presented at the time that the user input is received.

20. The method of claim 19, wherein the receipt of the user input signifies the beginning or ending of a chapter, and wherein recording chapter information comprises recording a chapter indicator for indicating the starting point or ending point of a particular portion of the continuous media data.

21. The method of claim 16, wherein recording chapter information comprises recording a chapter title.

22. The method of claim 21, wherein recording a chapter title comprises accessing customizable information stored in the memory device and basing the chapter title at least partially on the customizable information.

23. The method of claim 16, wherein receiving user input instructs a processor to begin or resume recording the continuous media data to the memory device and record chapter information for the location in the continuous media data where the processor begins or resumes recording.

24. A computer program product for creating chapters for continuous media data while recording the continuous media data, the computer program product comprising a computer-readable storage medium having computer-readable program code portions stored therein, the computer-readable program code portions comprising:
a first executable portion for receiving continuous media data;
a second executable portion for recording the continuous media data in a memory device;
a third executable portion for receiving user input while recording the continuous media data; and
a fourth executable portion for recording chapter information in the memory device based on the user input; wherein the chapter information comprises location information about a location of a chapter in the continuous media data.

25. The computer program product of claim 24, further comprising:
a fifth executable portion for presenting the continuous media data to the user while the processor is recording the continuous media data in the memory device.

26. The computer program product of claim 25, wherein the fourth executable portion is configured to record chapter information for a location in the continuous media data that substantially coincides with the location in the continuous media data presented at the time that the user input is received.

27. The computer program product of claim 26, wherein the fourth executable portion is further configured to record chapter information for indicating the starting point or ending point of a particular portion of the continuous media data.

28. The computer program product of claim 24, wherein the fourth executable portion is configured to record a chapter title.

29. The computer program product of claim 28, wherein the fourth executable portion is configured to access customizable information stored in the memory device and base the chapter title at least partially on the customizable information.

30. The computer program product of claim 24, wherein the second executable portion is configured to begin or resume recording the continuous media data to the memory device based on user input and wherein the fourth executable portion is configured to record chapter information for the location in the continuous media data where the processor begins or resumes recording.

31. A recording device comprising:
means for receiving continuous media data;
means for recording the continuous media data;
means for receiving user input while recording the continuous media data; and
means for recording chapter information based on the user input; wherein the chapter information comprises location information about a location of a chapter in the recorded continuous media data.

32. The recording device of claim 31, further comprising:
means for capturing the continuous media data.

33. The recording device of claim 31, further comprising:
means for presenting the continuous media data to the user while the recording the continuous media data.

34. The recording device of claim 33, further comprising:
means for recording chapter information for a location in the continuous media data that substantially coincides with the location in the continuous media data presented at the time that the user input is received.

35. The method of claim 31, further comprising:
means for recording chapter information whenever recording of the continuous media data begins or resumes.
